(19) United States
(12) Patent Application Publication
(10) Pub. No.: US 2022/0397445 A9
(43) Pub. Date: Dec. 15, 2022

(54) METHOD AND SYSTEM TO AUTOMATE A SURVEY PROCESS TO DETERMINE AVERAGE PASSENGER WEIGHT AND AVERAGE CHECKED BAG WEIGHT USED IN DETERMINING AIRCRAFT WEIGHT

(71) Applicant: C Kirk Nance, Keller, TX (US)

(72) Inventor: C Kirk Nance, Keller, TX (US)

(21) Appl. No.: 17/384,157

(22) Filed: Jul. 23, 2021

Related U.S. Application Data
(63) Continuation-in-part of application No. 16/552,383, filed on Aug. 27, 2019, now Pat. No. 11,416,871.
Application No. 16/552,383 is a continuation-in-part of application No. 15/917,149, filed on Mar. 9, 2018, now Pat. No. 11,410,183.
Application No. 15/917,149 is a division of application No. 14/924,332, filed on Oct. 27, 2015, now Pat. No. 10,089,634.
(60) Provisional application No. 63/056,273, filed on Jul. 24, 2020.

(51) Int. Cl. G01G 19/07; G01G 19/44

(52) U.S. Cl. CPC G01G 19/07; G01G 19/44

(57) ABSTRACT

A method and system for automating airline procedures, used is surveying passenger and checked baggage weights. A fully loaded aircraft is automatically weighed. A processing means subtracts weight values, including: aircraft OEW, fuel-weight, crew-weights, catering-weight, and cargo-weights; leaving only total passenger and checked baggage weights remaining. Opposing algorithms are applied to segregate total passenger weight from the total checked baggage weight; and each respective total weight is further divided by the known number of passengers to determine the average passenger weight, and the known number of checked bags to determine the average checked bag weight. Repeating these procedures for numerous flights, increases frequency of the automated survey process to a daily accumulation, to further refine to more precise average passenger weight and checked baggage weight; categorized by the day of the year, time of day, size of aircraft; and departure vs. destination cities.

This application claims the benefit of U.S. provisional patent application Ser. No. 63/056,273 filed Jul. 24, 2020, the contents of which are incorporated by reference herein in their entirety.

### BACKGROUND OF THE INVENTION

### 1. Field of the Invention

The present invention relates generally to determining aircraft weight and specifically to a method and system to automate a survey process to determine average passenger weight and average checked bag weight used in determining aircraft weight.

### 2. Description of the Prior Art

For safe operation of an aircraft, the weight of the aircraft must be determined prior to take-off. Airlines (also referred to as: FAA/Part 121 “Air Carriers”) have strict departure schedules, which are maintained to maximize aircraft utilization each day. Today's airline operations typically do not place fully loaded aircraft upon scales as a means to measure the aircraft weight, and the distribution of that weight commonly referred to as the aircraft Center of Gravity (“CG”); prior to an aircraft's departure (“dispatch”) from an airport gate.

On any single day within the United States, airlines average 28,537 departures; where each of these air carriers must determine the weight and CG for each aircraft prior to departure. United States population has progressively become heavier over the years; thereby the individual weight of each passenger on these aircraft has become heavier. Airlines operate on very strict time-schedules, where even a short departure delay occurring early in the day can have a ripple effect and create scheduling problems throughout the airline's remaining flight schedule. Aircraft “load planning” is a crucial part of keeping an airline operating on schedule. A scheduled aircraft departure will commence its load planning process up to one year prior to the actual flight. Airlines do not offer ticket sales for a flight, more than twelve months prior to the flight. As each ticket for a scheduled flight is sold, the average passenger and average checked bag weights are allocated into a load planning computer program, continually updating throughout the year the “planned load” for that flight. Aircraft have a Maximum Take-Off Weight “MTOW” limitation. Airline load planning procedures use assumptions as to the weight of passengers and baggage loaded onto the aircraft, to stay below the aircraft MTOW limitation.

Aircraft operational weights are limited by Federal Aviation Administration “FAA” Regulation. The FAA is the Regulatory Authority which regulates the design, development, manufacture, modification and operation of all aircraft operated within the United States, and will be referenced along with the term “Regulatory Authority” to indicate both the FAA and/or any governmental organization (or designated entity) charged with the responsibility for either initial certification of an aircraft or modifications to the certification of an aircraft. Examples of Regulatory Authorities would include: European Aviation Safety Agency “EASA”, within most European countries; Transport Canada, Civil Aviation Directorate “TCCA”, in Canada; Agência Nacional de Aviação Civil “ANAC” in Brazil; or other such respective Regulatory Authority within other such respective countries.

FAA Regulations (provided in the Code of Federal Regulations) are the governmental regulations, which detail the requirements necessary for an aircraft to receive certification by the Regulatory Authority within the United States. These would be equivalent to such regulations within the Joint Aviation Regulations “JARs” which are used in many European countries.

Title 14 of the Code of Federal Regulations, Part 25 refers to regulations that control the certification of Air Transport Category aircraft (“Part 25 aircraft”). Part 25 aircraft include most of the commercial passenger aircraft in use today. For example, Part 25 aircraft include Boeing model numbers: 737, 747, 757, 767, 777, 787; Airbus model numbers: A300, A310, A320, A330, A340, 350, 380; etc.

The FAA regulations allow for control mechanisms to assure Part 121 Air Carriers manage aircraft loading procedures, to confirm at the completion of the loading process that the aircraft load remains within the aircraft's certified forward and aft CG limits.

In particular:
Title 14—Code of Federal Regulations:
Part 121-695, subparagraph (d)
§ 121.695 Load Manifest: All Certificate Holders
   The load manifest must contain the following information concerning the loading of the airplane at takeoff time:
   (a) The weight of the aircraft, fuel and oil, cargo and baggage, passengers and crewmembers.
   (b) The maximum allowable weight for that flight that must not exceed the least of the following weights:
      (1) Maximum allowable takeoff weight for the runway intended to be used (including corrections for altitude and gradient, and wind and temperature conditions existing at the takeoff time).
      (2) Maximum takeoff weight considering anticipated fuel and oil consumption that allows compliance with applicable en route performance limitations.
      (3) Maximum takeoff weight considering anticipated fuel and oil consumption that allows compliance with the maximum authorized design landing weight limitations on arrival at the destination airport.
      (4) Maximum takeoff weight considering anticipated fuel and oil consumption that allows compliance with landing distance limitations on arrival at the destination and alternate airports.
   (c) The total weight computed under approved procedures.
   (d) Evidence that the aircraft is loaded according to an approved schedule that insures that the center of gravity is within approved limits.
   (e) Names of passengers, unless such information is maintained by other means by the certificate holder.

The FAA guidance listed above for determining the take-off weight of an aircraft; is often referred to as the Load Build-Up Method (“LBUM”), and can be summarize as:
beginning with the aircraft OEW: “Operating Empty Weight” (a measured weight of the empty aircraft, which must be re-measured on 36 month intervals),
added to OEW: is the weight of the flight and cabin Crew (a known weight associated with the number of crew members supporting that flight),
added to OEW+Crew: is the weight of the Fuel (onboard fuel indicators measure and display the weight of the fuel),
added to OEW+Crew+Fuel: is the weight of the Cargo (cargo weight is measured before it is loaded),
added to OEW+Crew+Fuel+Cargo: is the weight of the in-flight Catering (galley-carts have a measured weight, and the number of galley-carts for each flight are determined before being loaded),
added to OEW+Crew+Fuel+Cargo+Catering: is the assumed weight of the passengers, with carry-on items (a “designated” average weight of a typical passenger, multiplied by the number of passenger names listed on the load manifest)
added to the OEW+Crew+Fuel+Cargo+Catering+Passengers: is the assumed weight of the checked baggage (the “designated” average weight of a typical checked bag, multiplied by the number of bags which are manually counted by ground services baggage personnel, and loaded onto the aircraft. Though checked bags are often weighed at the ticket counter, that weighing is done to establish pricing for any potential heavy bag, which might be a couple of pounds over the respective airline's allowed limit; but that bag weight is not communicated to the load planners).
resulting in the total weight of a fully loaded aircraft.

All air carriers must have FAA approved procedures in place (“an approved schedule”) in which the air carrier will follow such procedures to insure each time an aircraft is loaded, the load will be distributed in a manner that the aircraft CG will remain within the forward and aft CG limitations. The FAA and the specific air carrier develop these procedures, which are often referred to as “loading laws,” and when implemented define how the aircraft is loaded.

An accurate determination of the total passenger weight portion of a flight can most accurately be accomplished by having a scale located at the entrance to the aircraft door, by which all weight that enters the aircraft would be measured and compiled. Though this solution may sound simple; but, having a measured weight of the passengers and their carry-on items for every departure could cause substantial disruption in an airline's daily flight schedule if the aircraft in which the “planned load” were compared to the actual load having all weights measured; then just moments before the aircraft is scheduled to depart, discover the aircraft weight now exceeds the weight limitations. An aircraft delay could result and many dissatisfied passengers, which might be required to be removed from their planned flight.

The FAA has established guidelines through the issuance of an Advisory Circular AC No: 120-27E, dated Jun. 10, 2005, “Aircraft Weight And Balance Control”; in which an airline is allowed to determine aircraft weight through the adoption of a “weight and balance control program” for aircraft operated under Title 14 of the Code of Federal Regulations (14CFR) part 91, subparts 121, 125 and 135. Part 121 deals with scheduled air carrier operations, including airlines such as American, Delta, United, and Southwest.

The aircraft operator will use an approved loading schedule to document compliance with the certificated aircraft weight limitations contained in the aircraft manufacturer's Aircraft Flight Manual (“AFM”), for the compiling and summing of the weights of various aircraft equipment, fuel and payload weights, along with the AC120-27E weight designations for passengers and baggage. These types of loading schedules are commonly referred to as the Load Build-Up Method (“LBUM”).

AC120-27E defines the Regulatory Authority's approved methods to determine the aircraft weight using “weight assumptions” which are the designated weight values for the typical average passenger, with carry-on items; and the typical checked bag. These designated weight assumptions are used instead of any requirement for scales to measure the total aircraft weight at departure. The fully loaded weight of the aircraft is established through a process of compiling the weights of various payload items based upon FAA approved “designated” average weights, for the varying elements such as passengers, carry-on baggage, checked baggage, crew weight, cargo weight and the weight of fuel loaded; onto a previously measured empty aircraft weight. AC120-27E designates for large aircraft (being aircraft certified to carry more than 70 passengers) approved Standard Weight assumption/designation for passengers and baggage as:
average summer passenger weight with carry-on items

average summer passenger weight with carry-on items

| | |
|---|---|
| May-October | 190.0 lb. |
| male average weight | 200.0 lb. |
| female average weight | 179.0 lb. |
| carry-on items average weight | 16.0 lb. |

average winter passenger weight with carry-on items

| | |
|---|---|
| November-April | 195.0 lb. |
| average checked bag weight | 28.9 lb. |

average winter passenger weight with carry-on items

TABLE 3-3
Minimum Sample Sizes

| | Minimum | Tolerable |
|---|---|---|
| Survey Subject | Sample Size | Error |
| Adult (standard adult/male/female) | 2,700 | 1% |
| Child | 1,400 | 2% |
| Checked bags | 1,400 | 2% |
| Heavy bags | 1,400 | 2% |
| Planeside loaded bags | 1,400 | 2% |
| Personal items and carry-on bags | 1,400 | 2% |
| Personal items only (for operators | 1,400 | 2% |
| with a no carry-on bag program) | | |

It should be noted that the Regulatory Authorities have various practices to allow air carriers the options for determining passenger and baggage weights, such as:
Measuring each passenger and baggage on a scale,
Use of the CDC-NHANES periodic survey of average population weight, plus the addition of a various clothing weight, determined by seasonal temperature changes
Manually surveying the passenger and baggage weights on prescribed periodic schedules.

On May 16, 2019; the FAA issued AC120-27F (herein referred to as “27F”) to replace and cancel AC120-27E (herein referred to as “27E”), dated Jun. 10, 2005. The vast majority of the regulatory guidance of 27E remained within 27F, but with one notable and major change: the FAA no longer establishes and provides the designated average passenger weight and average baggage weight values. The burden, liability, and responsibility for determining the average passenger and baggage weights are now delegated to each individual airline. Below are excerpts from 27F, which better define the prerequisites needed to meet the FAA's guidance for performing weight surveys, and establishing the sample-size for the number of surveyed passengers; to establish average passenger and baggage weights.

In particular, Advisory Circular AC120-27F:
Title 14—Code of Federal Regulations:
Part 91 subpart K and parts 121, 125 and 135

3.3 Average Weights Based on Survey Results.
3.3.1 What Should an Operator Consider when Designing a Survey?
   3.3.1.1 This paragraph provides operators with an acceptable survey method to use in determining average weights for a W&B control program. This paragraph also describes how an operator can conduct a survey to count personal items, carry-on bags, and checked bags to determine an appropriate allowance for those items. In addition, an operator may use the methods described in this paragraph to conduct a survey to determine the percentage of male and female passengers and to calculate an average passenger weight.
   3.3.1.2 Surveys conducted correctly allow an operator to draw reliable inferences about large populations based on relatively small sample sizes. In designing a survey, an operator should consider:
      1. The sample size required to achieve the desired reliability,
      2. The sample selection process, and
      3. The type of survey (average weights or a count of items).
3.3.2 What Sample Sizes Should an Operator Use?
   Several factors must be considered when determining an adequate sample size. The more varied the population, the larger the sample size required to obtain a reliable estimate. Paragraph 3.3.3 provides a formula to derive the absolute minimum sample size to achieve a 95 percent confidence level.
3.3.3
   Table 3-3, Minimum Sample Sizes, has been provided for those operators that wish to use calculations other than those listed in paragraph 3.3.3. Table 3-3 provides the operator with an acceptable number of samples that may be collected to obtain a 95 percent confidence level and lists the tolerable error associated with each category.

$$S = \frac{\sqrt{{{\sum }_{j - 1}}^{n} {( {x}_{j} - \overline{x} )}^{2}}}{\sqrt{n - 1}}$$

3.3.4 When Conducting a Survey, Can an Operator Collect a Smaller Sample Size than that Published in Table 3-3?
   If the operator has chosen to use a sample size that is smaller than that provided in Table 3-3, the operator should collect a sufficient number of samples to satisfy the following formulas:

$$e = \frac{1.96 ⋆ s ⋆ 100}{\sqrt{n} ⋆ \overline{x}}$$

Where:
   s is the standard deviation
      n is the number of points surveyed
      xⱼ is the individual surveyed weights
      x̅ is the sample average

| | |
|---|---|
| Average passenger weight-summer | 190.0 lb. |
| Average passenger weight-winter | 195.0 lb. |
| Average bag weight | 28.9 lb. |

Where:
   e is the tolerable error percentage
3.3.5 What Sampling Method Should an Operator Use?
   3.3.5.1 Random Sampling. An operator conducting a survey must employ random sampling techniques. Random sampling means that every member of a group has an equal chance of being selected for inclusion in the sample. If an operator conducts a survey that does not employ random sampling, the characteristics of the selected sample may not be indicative of the larger group as a whole. Because of this, any conclusions drawn from such a survey may not be valid.
   3.3.5.2 Random Sampling Methods. The following are two examples of random sampling methods that an operator may find appropriate for the type of survey conducted. An operator may also consult a basic publication on statistics to determine whether a different random sampling method is more appropriate.
      3.3.5.2.1 Simple Random Selection. An operator should assign a sequential number to each item in a group (such as passengers waiting on a line or bag claim tickets). Then the operator randomly selects numbers and includes the item corresponding with the number in the sample. The operator repeats this process until it has obtained the minimum sample size.
      3.3.5.2.2 Systematic Random Selection. An operator should randomly select an item in sequence to begin the process of obtaining samples. The operator should then use a predetermined, systematic process to select the remaining samples following the first sample. For example, an operator selects the third person in line to participate in the survey. The operator then selects every fifth person after that to participate in the survey. The operator continues selecting items to include in the sample until it has obtained the minimum sample size.
   3.3.4.3 Elective Passenger Participation. Regardless of the sampling method used, an operator has the option of surveying each passenger and bag aboard the aircraft and should give a passenger the right to decline to participate in any passenger or bag weight survey. If a passenger declines to participate, the operator should select the next passenger based on the operator's random selection method rather than select the next passenger in a line. If a passenger declines to participate, an operator should not attempt to estimate data for inclusion in the survey.
3.3.5 What Should an Operator Consider when Developing a Survey Plan and Submitting it to the FAA?
   3.3.5.1 Developing a Survey Plan. Before conducting a survey, an operator should develop a survey plan. The plan should describe the dates, times, and locations the survey will take place. In developing a survey plan, the operator should consider its type of operation, hours of operation, markets served, passenger mix, and frequency of flights on particular routes. In general, an operator should avoid conducting surveys on holidays or other dates that are not representative of normal operations.
   3.3.5.2 Submitting the Survey Plan to the FAA. An operator should submit its survey plan to the FAA at least 30 calendar-days before the operator expects to begin the survey. Before the survey begins, the operator's principal inspector (PI) will review the plan and work with the operator to develop a mutually acceptable plan. During the survey, the PI will oversee the survey process to validate the execution of the survey plan. After the survey is complete, the PI will review the survey results and issue the appropriate OpSpecs or MSpecs. Once a survey begins, the operator should continue the survey until complete, even if the initial survey data indicates that the average weights are lighter or heavier than expected.
3.3.6 What General Survey Procedures Should an Operator Use?
   3.3.6.1 Survey Locations. An operator should accomplish a survey at one or more airports that represent at least 15 percent of an operator's daily departures. To provide connecting passengers with an equal chance of being selected in the survey, an operator should conduct its survey within the secure area of the airport. An operator should select locations to conduct its survey that would provide a sample that is random and representative of its operations. For example, an operator should not conduct a survey at a gate used by shuttle operations unless the operator is conducting a survey specific to that route or the operator only conducts shuttle operations.
   3.3.6.2 Weighing Passengers. An operator that chooses to weigh passengers as part of a survey should take care to protect the privacy of passengers. The scale readout should remain hidden from public view. An operator should ensure that any passenger weight data collected remains confidential.
   3.3.6.3 Weighing Bags. When weighing bags, the operator should account for all items taken aboard the aircraft as well as checked-in items. In addition, the operator should ensure a proper accounting for all planeside loaded items, and have procedures on how to handle these items.
      Note: The operator should ensure that all scales are certified and calibrated by the manufacturer or a certified laboratory, such as a civil department of weights and measures, or the operator may calibrate the scale under an approved calibration program. The operator should also ensure that the scale is calibrated within the manufacturer's recommended time, or time periods, as specified in the operator's approved calibration program.
   3.3.6.4 Rounding in Survey Collection. When collecting survey data, values should be recorded to the same precision as the accuracy of the collection method, including considerations such as any calibration tolerance or estimation on analog scales. For example, when using scales calibrated to the nearest pound, it is just as incorrect to record values at the tenth of a pound as it is to round to the nearest 10 pounds.
   3.3.6.5 Surveys for Particular Routes. An operator may conduct a survey for a particular route if the operator believes that the average weights on that route may differ from those in the rest of its operations. To establish a standard average passenger weight along the route, an operator may survey passengers at only one location. However, an operator should conduct surveys of personal items and bags at both the departure and arrival locations of the route, unless the operator can substantiate there is no significant difference in the weight and number of bags in either direction along the route.

An aircraft is typically supported by plural and in most cases three pressurized landing gear struts. The three landing gears are comprised of two identical main landing gear struts, which absorb landing loads and a single nose landing gear strut used to balance and steer the aircraft as the aircraft taxi on the ground. Designs of landing gear incorporate moving components, which absorb the impact force of landing. Moving components of an aircraft landing gear shock absorber are commonly vertical telescopic elements. The telescopic shock absorber of landing gear comprise internal fluids, both hydraulic fluid and compressed nitrogen gas, and function to absorb the vertical descent forces generated when the aircraft lands. While the aircraft is resting on the ground, or taxiing to and from the gate; the aircraft is “balanced” upon three pockets on compressed gas within the landing gear struts.

Monitoring the distribution and subsequent re-distribution of aircraft loads can be identified by measuring changes in the three landing gear strut internal pressures, which will in turn identify the aircraft CG. The implementation of changes to aircraft loading procedures for both the assumptions as to the numerous varieties of weight items which can be loaded onto the aircraft, as well as the locations within the aircraft the weights are placed; further combined with strict auditing procedures to identify non-recognized weight errors associated with the weight assumptions; further creates the need for better determination of average passenger and bags weights.

### SUMMARY OF THE INVENTION

The methods and apparatus described herein provide a process for first measuring the weight of the fully loaded aircraft, then reversing-the-steps of the LBUM process, to identify the total weight of the passenger and baggage (“total payload weight”). The “total payload weight” includes both passenger weight (with carry-on items) and total checked baggage weight. Algorithms are used which incorporate the FAA's “27E” designated average checked bag weight, multiplied by the number of checked bags loaded on that aircraft to determine the total checked baggage weight. The total checked bag weight is subtracted from the “total payload weight” to identify a weight associated with the total number of passengers, with carry-on items.

The total passenger weight is divided by the number of names listed on the load manifest, to identify the individual average passenger weight (with carry-on items) for the respective flight. The process is repeated for multiple flights. Large domestic air carriers typically have over 4,000 daily departures. Thousands of average passenger weight values are compiled daily; until a typical average passenger weight is refined to a confident number. Upon defining the average passenger weight with a high level of confidence, the process is altered for subsequent flights, to then utilize the refined average passenger weight, multiplied by the number of names listed on the load manifest, to determine the total weight of the passengers with carry-on items; then subtracted from the “total payload weight” to identify the total weight associated with the checked baggage. The total checked baggage weight is divided by the number of checked bags, manually counted for that flight, to determine the average checked bag weight. These corresponding procedures are repeated utilizing the airline's entire fleet of aircraft types, to generate thousands of automated weight surveys each day. The large quantities of collected weight values are assessed, to established a more precise average weight for both passengers and checked baggage.

This invention offers new methods with apparatus to frequently measure the weight of a fully loaded aircraft, in support of automated passenger and baggage weight survey procedures and a records-keeping data-base, to inventory a more precise set of average passenger weights and checked baggage weights, for subsequent use to increased accuracy in the aircraft weight determinations for Regulated aircraft.

Additionally, the creation of a passenger and baggage weight database which not only offers a generic average passenger and baggage weight for a typical airline flight; but creates segments within the database, associated with: the months of the years, the time of day, the departure and arrival cities, as well as to associate an average passenger and baggage weight to a specific airframe type. Narrow-body aircraft typically fly domestic routes, while wide-body aircraft typically fly more international routes. Having average passenger and baggage weight data specific to the size of aircraft being operated can increase the accuracy of the weight assumptions, thereby increasing the safety of each flight.

There is provided methods with apparatus supporting a process to automate an airline's survey process, to determine the typical average passenger weight and checked baggage weight. The aircraft having a system for measuring the fully loaded weight of the aircraft, which include the weights of: empty aircraft, flight and cabin crew, fuel carried within the various fuel tanks, cargo loaded beneath the cabin floor, catering items and/or galley carts, passengers with carry-on items, and checked baggage.

In accordance with another aspect, the step of determining the values of the typical average passenger weight and checked baggage weight further comprises the step of identifying differences in the average passenger and check baggage weight, based upon different seasons of the year.

In accordance with another aspect, the step of determining the values of the typical average passenger weight and checked baggage weight further comprises the step of identifying differences in the average passenger and check baggage weight, based upon the specific time of day for travel.

In accordance with another aspect, the step of determining the values of the typical average passenger weight and checked baggage weight further comprises the step of identifying differences in the average passenger and checked baggage weight, based upon different departure to arrival city-pairings; and illustrate variations in weights between vacation travel destinations, to those of business travel destinations.

In accordance with another aspect, the step of determining the values of the typical average passenger weight and checked baggage weight further comprises the step of identifying differences in the average passenger and checked baggage weight, associated with different sizes of the aircraft being operated. As an example: the Boeing 737 “narrow-body” typically operates in domestic routes, typically with fewer and lighter baggage; and the Boeing 777 “wide-body” typically operates on long-haul and international routes, typically with heavier baggage.

In accordance with another aspect, the step of determining the values of the typical average passenger weight and checked baggage weight further comprises the step of compiling an average passenger and checked baggage “weight data-base” which can be made available to domestic and international air carriers with fewer aircraft within their fleets, and operating fewer flights; thus having less volume within their passenger pools to develop more accurate average passenger and baggage weight values. Availability of this broad scope data-base will offer a higher level of safety for the smaller fleet operations of air carriers.

Statistical compilations of the average passenger and checked baggage weight values are refined through daily analysis within computer programs and updated instantaneously to those air carriers participating in the information library and data-base, which allow each air carrier to immediately update their LBUM programs, with even slight revisions to the average passenger and bag weight values, to further increase the accuracy within the specific aircraft cabin configuration used for their load planning programs; where the planning model data further compared to measured recordings of the actual weight of the fully loaded aircraft, at dispatch; allowing adjustments to their loading model weights more often than on 3-year intervals, being the requirement to re-survey the their flying customers. Having more precise average weight values for passengers and checked baggage increased the confidence of load planners, that their planned loads will be and become more congruent with the actual measured aircraft weight.

The apparatus and processes for automating the passenger and baggage weight surveys shall be fully described in the new methods of this invention, and will be explained fully throughout the Figures and Descriptions herein.

### BRIEF DESCRIPTION OF THE DRAWINGS

FIG. 1 is a side view of a typical Boeing 737-800 transport category aircraft, with nose and main landing gear of the aircraft deployed and resting on the ground; with various components of the invention including an OnBoard Weight and Balance System with a first on-aircraft computer, a second off-aircraft computer residing in a Centralized Data Services building, and a third off-aircraft computer residing at a separate building for the Network Operations Center of an airline.

FIG. 2 is a side view of a typical aircraft landing gear strut, with various elements of an onboard aircraft weighing system, including a strut pressure sensor, attached to the landing gear strut.

FIG. 3 is a rear view of a typical aircraft landing gear strut, with various elements of an onboard aircraft weighing system, including an axle deflection sensor, attached to the landing gear strut.

FIG. 4 is a chart illustrating a typical Load Build-Up Method “LBUM” used by airlines to determine total aircraft weight, for take-off.

FIG. 5 is a chart illustrating a reversal of the steps of the typical Load Build-Up Method “LBUM”, beginning with a measured aircraft weight, and deducting the weight values of all items other than passenger weight, to determine a total passenger weight, divided by the number of passengers; to automatically identify the average passenger's weight.

FIG. 6 is a chart showing 1,400 surveyed airline flights, illustrating the variations in average passenger weight determinations from each flight, with additional filtering to identify and remove significantly high and low average passenger weight ranges as outliers; to determine a mean value of 200.38 lb. as the average passenger weight from the 1,400 flights surveyed.

FIG. 7 is a chart similar to FIG. 5, illustrating a process for using the more precise average passenger weight, to automatically identify the average checked bag's weight.

FIG. 8 is a chart, which illustrates current FAA requirements, allowing an airline “fleet average weight” up to 21½ years between respective aircraft re-weighs.

FIG. 9 is a chart similar to FIG. 7, illustrating the process for using the more precise average passenger and bag weights, to automatically survey, audit and identify changes in the aircraft's previously measured Operating Empty Weight.

FIG. 10 is a chart similar to FIG. 9, illustrating the process for using the more precise average passenger and bag weights, to automatically identify fuel indicator accuracy, or possible calibration drift creating inaccuracies.

FIG. 11 illustrates multiple airlines participating in the automated survey program, transmitting sensor data related to measured aircraft weights to the Centralized Data Service provider, which subsequently provides the average weight data to airlines participating in the survey program, as well as allowance for smaller airlines choosing to not have the onboard weight measurement system installed, but instead continue using AC120-27F and LBUM; with these more precise average passenger and baggage weight assumptions, allowing better load planning and accuracy for the non-participating airlines.

FIG. 12 is a block diagram of the system apparatus and software programs.

### DETAILED DESCRIPTION OF THE PREFERRED EMBODIMENT

In the description herein, the disclosures and all other information of my earlier U.S. Pat. Nos. 5,214,586; 5,548,517; 6,128,951; 6,237,406; 6,237,407; 8,543,322; 9,927,319; 10,089,364 and 10,295,397 as systems for measuring the weight of a fully loaded aircraft, are incorporated by reference.

The present invention utilizes prior art methods to physically measure the weight of an aircraft as it rest on the ground. Parallel measurements of aircraft weight by independent weight sensing features allow for an increase in confidence of the physical weight measurements and further offer cross-verification for physical weight measurement system accuracy.

In today's airline operations, aircraft Maximum Take-Off Weight determinations are computed by a Load Build-Up Method, which processes and procedures have remained relatively un-changed for the past 50 years. Jun. 10, 2005 the FAA published an Advisory Circular AC120-27E offering guidance for an approved method to determine the aircraft weight by “computations” which are independent of any requirement to measure of the weight of the aircraft fully loaded with passengers. Typically today, the fully loaded weight of the aircraft is calculated by a process of compiling the weights of various payload items based upon FAA “designated” average weights, for the varying elements such as passengers, carry-on baggage, checked baggage, crew weight; along with cargo weight and the weight of fuel loaded; onto a previously measured empty aircraft weight. This method of calculating the aircraft weight based on the summing of the various weight elements loaded on to a pre-measured empty aircraft weight is often mentioned as the Load Build-Up Method and in this description shall be referred to as the “LBUM”.

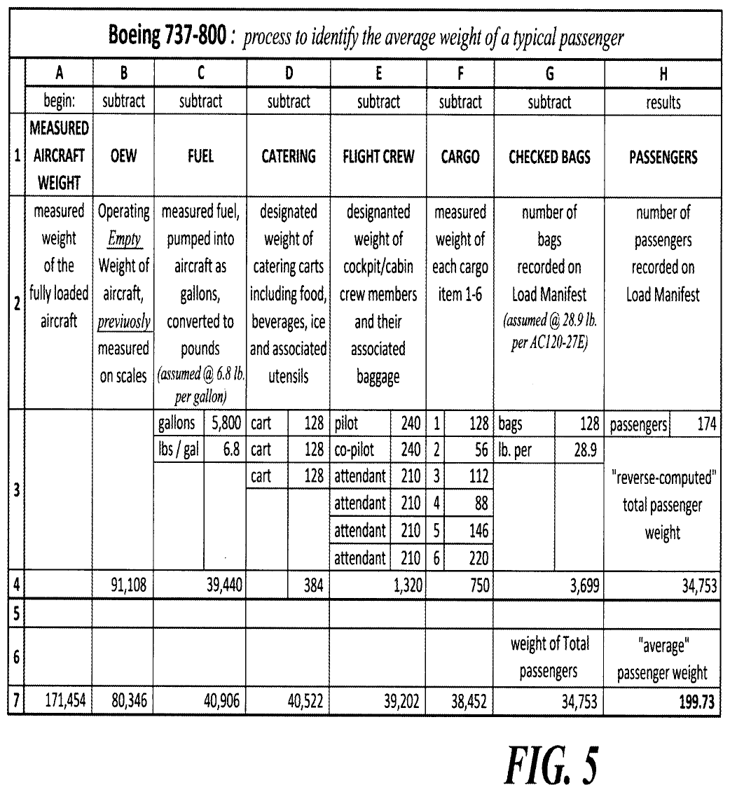

The FAA's AC 120-27E designated weight assumptions for airline passengers and baggage are:

| | |
|---|---|
| 53 | data point representing a single airline flight used to survey and determine the |
| | average weight of a passenger; |
| 55 | horizontal solid-line representing the mean of total surveyed flights, to determine |
| | average passenger weight across the 1,400 flights; |
| 57 | data point identified as a flight with the average passenger weight, greater than |
| | the mean; |
| 59 | data point identified as a flight with the average passenger weight, lesser than |
| | the mean; |
| 61 | horizontal dash-line representing the filtering threshold for identification of |
| | surveyed average passenger weight “high outlier”; |
| 63 | horizontal dash-line representing the filtering threshold for identification of |
| | surveyed average passenger weight “low outlier”; |
| 65 | data point identified as a flight with average passenger weight greater than the |
| | “high outlier” filter; |
| 67 | data point identified as a flight with average passenger weight lesser than the |
| | “low outlier” filter; |
| 69 | the specific data point representing the flight used as the Example in FIG. 5; |
| | determining the average passenger weight of 199.73 |

On May 16, 2019 the FAA published Advisory Circular AC120-27F, being the most recent revision to 27E. A notable and major change in 27F is that the FAA no longer designates the average passenger, average carry-on item and average checked baggage weights.

On the actual day of a flight, typically two hours prior to the departure of the flight, that flight's automated load planning program will be transferred to the desktop computer display of one of the airline's Flight Dispatchers. It is the responsibility of the Flight Dispatcher to then monitor the planned load of that flight as passengers check-in at the gate. The number of ticketed passengers and allocations for checked bags have been input to the load-planning program. Typically this process goes without interruption and the aircraft will dispatch on schedule, as planned. As the door of the aircraft is closed and the load-plan is closed-out by the Flight Dispatcher, the “planned load” will always match the “departure load” as submitted to the FAA; because both are based on the same compilation of weight assumptions used in determining the LBUM. Many if not most airlines currently dispatch their aircraft under FAA approved LBUM procedures; a method which helps to keep the airlines on schedule.

Throughout the description herein, examples will be shown for calculations to determine aircraft take-off weight, being a weight that must never exceed the aircraft's certified Maximum Take-Off Weight (“MTOW”) limitations. The Boeing 737-800 is one of the most common commercial “narrow-body” aircraft flown worldwide by today's airlines and shall be used as the subject aircraft throughout the examples and illustrations in this invention.

An aircraft is typically supported by plural landing gear struts. In many if not most cases, aircraft are supported by three landing gear struts. Each landing gear strut is designed much like, and incorporates many of the features of a typical telescopic shock absorber. The shock absorber of the landing gear strut comprises internal fluids, of both hydraulic oil and compressed gas. More simply said . . . “the weight of an aircraft rests on three pockets of compressed gas.”

The average population weight has been documented as becoming heavier year-after-year. For this reason, filled aircraft will (if measured) have a heavier measured weight than the weight computed by population weight data determined in 27E. Airlines throughout the United States are using this stale weight data in the current 28,537 aircraft dispatches per day.

This invention provides methods of identifying, defining and illustrating a means to automate the airline's weight surveying procedures.

The weight of the aircraft supported by the above mentioned pockets of compressed gas is transferred down the landing gear strut to the landing gear axles, which bear the load and are supported by the landing gear tires. As weight is added to the aircraft, the axles will bend and deflect with the addition of more load. As an alternate means of determining aircraft weight, the bending/deflection of the aircraft landing gear axles can be monitored and measured with such axle deflection being directly proportional to the additional amount of weight added. The deflection of the landing gear axles represent the same load as supported by the pockets on compressed gas, thus both provide methods of determining aircraft weight, which may run parallel.

Regulatory Authorities do not require airlines to weigh aircraft on scales to determine aircraft take-off weight, as a means to confirm aircraft weight limitations have not been exceeded. The procedures implemented in this invention for pre-take-off aircraft weighings compared to planned loads, facilitate the development of a new category of “reliability program” implemented; to assure Regulatory Authorities that a load which is planned near but not exceeding the take-off weight limitation are measured to assure the weight limitations are not exceeded. Such fully loaded aircraft take-off weighings, will create a Superior Level of Safety to that of aircraft currently operating with un-measured weights, which un-measured weights might allow exceedance, beyond of certified weight limitations.

Use of prior art aircraft weighing systems are implemented to measure aircraft take-off weight, along with unique methods and procedures for the review, analysis and documentation of a measurement of the total passengers and checked baggage weight values, for further development of a method to determine and validate the average “single passenger” and “single checked bag” weight values, currently used in LBUM procedures; which will provide the necessary evidence for Regulatory Authorities' granting approval for the automation of the weight survey process to establish more accurate average weight values, to those being used today.

The present invention offers apparatus and methods utilizing a variety of sensors for collecting landing gear load data to continually update a variety of interrelated computer software programs, used in the more advanced aircraft weight measuring systems.

To summarize this system, apparatus and methods used for continuous monitoring and measuring by various sensors include:
Strut pressure sensor
Landing gear strut axle deflection sensor
Aircraft pitch indicator
Aircraft 3-axis acceleration indicator
Aircraft ground speed indicator
On-aircraft computer to collect aircraft and landing gear data
Off-aircraft computer to process collected landing gear data, with software functionality to determine aircraft weight and CG
Wireless communication capabilities between on-aircraft computer and off-aircraft computer data base
Wireless communication capabilities between off-aircraft computer data-base and air carriers receiving the average passenger and checked baggage weight data

This invention provides methods of identifying, defining and illustrating variations in average passenger and checked baggage weights across numerous geographic regions and variations in the seasonal changes in temperature. Average passenger (and checked baggage) weight values are determined, recorded and stored within a data-base; assigned and cross-referenced into categories of: date, time, aircraft size, and geographic region; allowing their current and future use as reference points in the comparison of, and changing trends in, average weight patterns; which are monitored and used as a base-line benchmark in subsequent average weight computations, to increase the confidence level when determining a value for average weight value; used by airline load planners for the next day's flights. Allowing the logic within the software programs to identify and learn, with the additions of the ever-expanding individual data-points complied within the data-base.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present disclosure. Thus, the appearances of such phrases in various places throughout this specification are not necessarily all referring to the same embodiment. Furthermore, the particular features, structures, or characteristics may be combined in any suitable manner on one or more embodiments without limitation. The detailed description illustrates by way of example, not by way of limitation, the principles of the invention. This description will clearly enable one skilled in the art to make and use the invention, and describes several embodiments, adaptations, variations, alternatives, and uses of the invention, including what is presently believed to be the best mode of carrying out the invention.

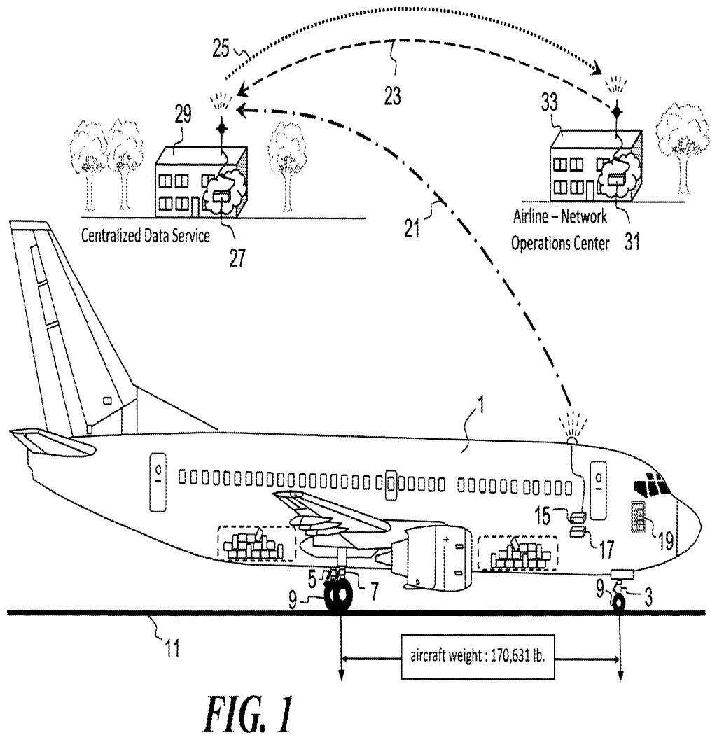

Referring now to the drawings, wherein like reference numerals designate corresponding parts throughout the several views and more particularly to FIG. 1 there is shown a side view of a typical Boeing 737-800 transport category “Part 25” aircraft 1, supported by tricycle landing gear configuration consisting of a nose landing gear 3, and two identical main landing gears, including a left main landing gear 5 and a right main landing gear 7 (both main landing gear positioned at the same location longitudinally along the aircraft, but shown in perspective view for this illustration).

The total weight of the aircraft rest upon the combined left and right main landing gears 5, 7 and nose landing gear 3.

Landing gears 3, 5 and 7 distribute the weight of aircraft through tires 9, which rest on the ground 11. A commercially available OnBoard Weight and Balance System (“OBWBS”) which is modified and utilized as a component of this invention, measures the weight of aircraft 1, supported at each respective landing gear, and in this example identifies the total weight of aircraft 1 at 170,631 lb.

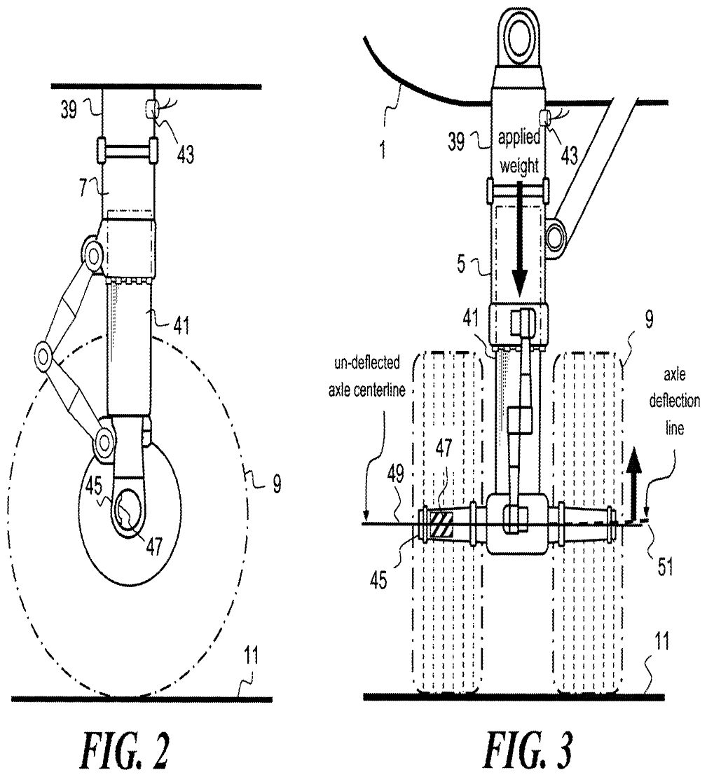

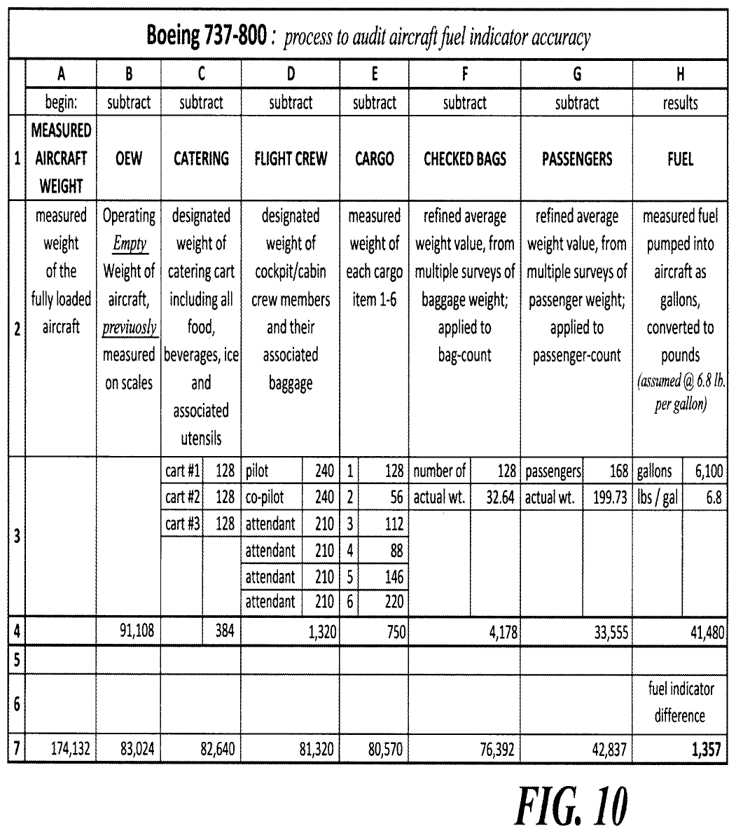

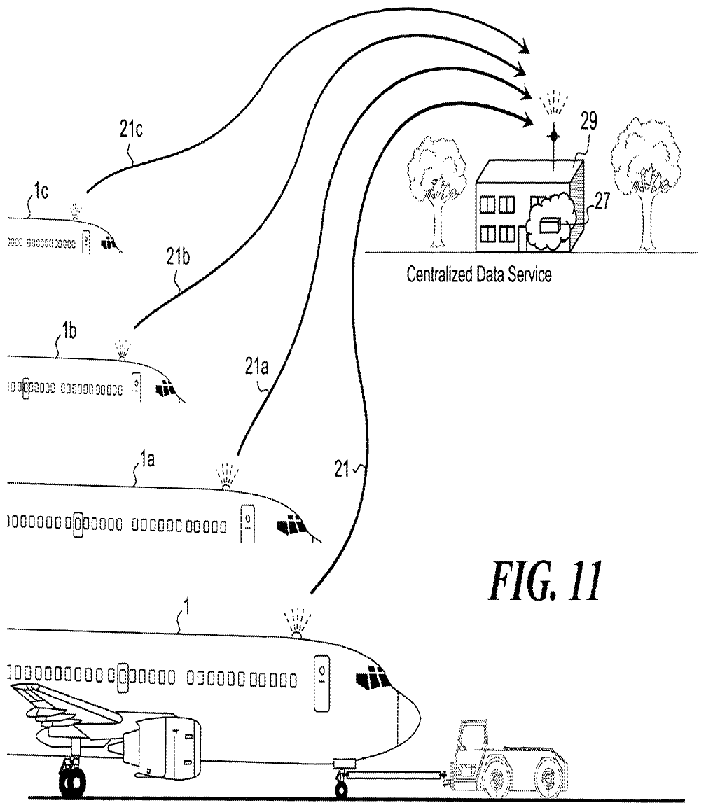

Electronic components of the OBWBS, attached to aircraft 1, are an on-aircraft data acquisition computer 15 which incorporate new software programs (defined and shown in FIG. 10), and an on-board aircraft inertial system 17, which measures aircraft pitch, ground speed and 3-axis acceleration; and supplies that data to computer 15. Optional cockpit display 19 may be utilized, but with today's advanced aircraft information systems having numerous transmission capabilities to the pilots, for receiving aircraft weight and CG information, thus eliminates the requirement for a cockpit display 19. On-aircraft computer 15 receives input data from landing gear strut pressure sensors 43 and landing gear axle deflection strain gauge sensors 47 (shown in FIG. 2 and FIG. 3). On-aircraft computer 15 contains various internal circuit boards for the collection and transmission of strut pressure data and axle deflection data from respective landing gears 3, 5 and 7 to a first off-aircraft computer 27, which is housed within a Centralized Data Service provider's building 29. On-aircraft computer 15 communicates wirelessly with first off-aircraft Centralized Data Services computer 27. First off-aircraft computer 27 receives, sensor input data recorded by on-aircraft computer 15 via wireless communication data transfer 21. The airline's Network Operations Center (“NOC”) is housed in a different building 33, with a dedicated second off-aircraft computer 31, available to transmit flight manifest data, including the number of passengers, number of checked bags, OEW, number of flight crew, cargo weight and catering weight on any respective flight, to Central Data Services first off-aircraft computer 27 via wireless data transmission 23. On-aircraft computer 15 receives fuel weight data from the aircraft's on-board fuel indicators. Upon receiving both aircraft data via data transmission 21 and load manifest data via wireless transmission 23 from airline second off-aircraft computer 31; Central Data Services first off-aircraft computer 27 will process the corresponding data to resolve for the average passenger weight and average checked baggage weight for the respective flight.

The process to resolve for average passenger and baggage weight takes approximately ¾ of a second, at which time Centralized Data Services first off-aircraft computer 27 will update the data-base and transmit the updated and refined information back to airline second off-aircraft computer 31 via wireless data transfer 25. Airline second off-aircraft computer 31 will use the updated and refined average passenger weight and average baggage weight data to make adjustment to the average weights in their existing load planning programs, that current and subsequent measurements of total aircraft weight will more closely match the weight established by the load planning programs.

Referring now to FIG. 2 which illustrates apparatus for a typical OBWBS, and attached to a landing gear; used to measure the weight of aircraft 1, there is shown a side view of a typical aircraft telescopic right main landing gear strut 7, comprising the landing gear strut cylinder 39, in which strut piston 41 moves telescopically within strut cylinder 39. A pressure sensor 43 monitors changes in pressure within the contained pressure vessel of landing gear 7. All weight supported by tire 9 is transferred through axle 45, to piston 41; resulting in variations to landing gear strut 7 internal pressure, as recorded by pressure sensor 43. As weight is applied to landing gear strut 7, telescopic piston 41 will recede into strut cylinder 39, reducing the interior volume within landing gear strut 7 and increasing internal pressure in proportion to the amount of additional weight applied. Corrections are made for pressure errors caused by landing gear strut seal friction; and the un-sprung weight for landing gear components located below the pressure vessel within landing gear 7 are added, allowing landing gear strut 7 to functions as an aircraft weighing scale, with the capability of folding up and moving with aircraft 1. As weight is added to landing gear strut 7, axle 45 will deflect in direct proportion to the amount of added weight. Deflection of axle 45 (shown in FIG. 3) is measured by a strain gauge sensor 47, with an alternate means for OBWBS to measure the weight supported by landing gear 7.

Referring now to FIG. 3 which illustrates an alternate view of the apparatus for a typical OBWBS, used to measure aircraft 1 weight, where there is shown a rear view of a typical aircraft telescopic left main landing gear strut 5 comprising landing gear strut cylinder 39, in which strut piston 41 moves telescopically within strut cylinder 39. Landing gear strut piston 41 is attached to an axle 45, which uses a wheel and tire 9 to transfer aircraft weight to the ground 11. A pressure sensor 43 monitors pressure within landing gear 5. Pressure measured by pressure sensor 43 is proportional to the amount of applied weight onto landing gear 5. The applied weight to landing gear 5 is also measured by axle deflection sensor 47, which is bonded to axle 45. Axle deflection sensor 47 can be of the strain gauge variety, which measures the vertical deflection of axle 45. A bold solid line 49 is shown running horizontal across the center-line of landing gear axle 45 and represents an un-deflected stance of the landing gear axle 45. As additional weight is applied the landing gear strut 5, axle 45 will deflect. A bold dashed-line 51 illustrates a very slight curve; representing vertical deflection from solid line 49 of axle 45 and is shown running adjacent to the un-deflected bold solid line 49. The amount of deflection of landing gear axle 45 is directly proportional to the amount of weight applied. As weight is applied to landing gear strut 5, the increase in weight will be immediately sensed by the additional deflection of axle 45 and measured by strain gauge sensor 47. Axle deflection sensor 47 will transmit a signal representing the weight applied to the landing gear strut 5, to the OBWBS computer 15 (shown in FIG. 1).

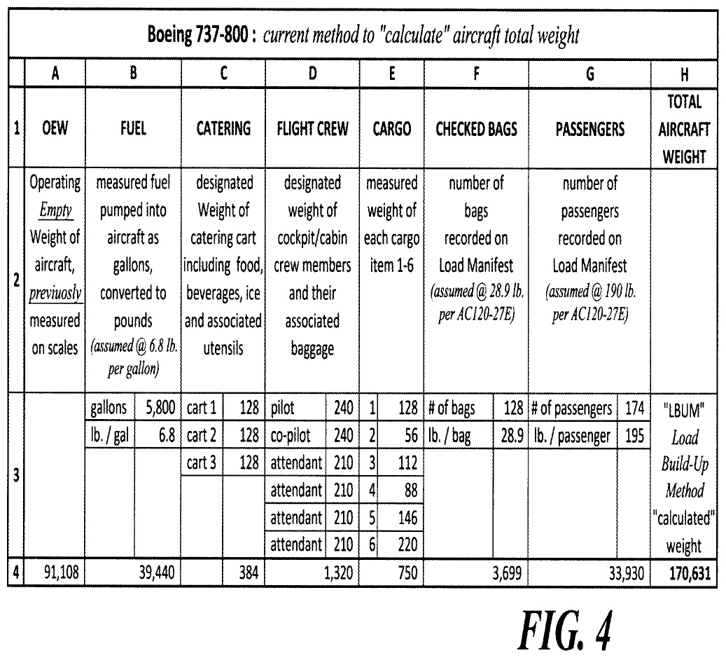

Referring now to FIG. 4 there is shown a chart illustrating one of the current methods airlines use to “calculate” aircraft total weight, listing the various weight categories typically use to determine the fully loaded aircraft weight, before flight. This practice is commonly called the Load Build-Up Method “LBUM”. The aircraft selected for the example is the Boeing 737-800; with the chart divided into vertical columns: A, B, C, D, E, F, G and H as the various weight categories; with subordinate horizontal rows 1, 2, 3, and 4 as the steps used in the computation of each weight category.

We begin this 1^{st} example with:
Column A representing the Operating Empty Weight (“OEW”). The OEW is the weight of the empty aircraft. One method to measure the operational empty weight of the aircraft is to roll the aircraft onto platform-weighing scales, with one landing gear resting on each of the respective scales. Each scale measures the weight supported by each respective landing gear and the weights are added together to measure the aircraft total weight. An alternate method to measure the empty weight of an aircraft is to place it onto tripod floor-jacks, then lift the entire aircraft up and off of the hanger floor. A load-cell is located between the aircraft and the top of each floor-jack; so that once the aircraft is suspended above the floor, the weight of the aircraft rests on the three load-cells. The OEW is thereby measured and the aircraft CG is further determined from the measured aircraft weights. Though the term OEW implies the aircraft as totally empty, the aircraft is actually empty of fuel, payload and crew. Other weight associated with items such as engine and hydraulic system fluids, in-flight magazines, galley items such as coffee-makers, disposable products and other lavatory items are considered part of, and are included in the OEW. In this example, the OEW of the Boeing 737-800 aircraft is 91,108 lb. The FAA requires aircraft to be reweighed at 36-month intervals, to account for changes in OEW (shown in this Column A, Row 4).
Column B representing the weight of the fuel, which is carried within the aircraft fuel tanks. In the determination of aircraft total weight, the fuel weight is determined by recording aircraft fuel indicator readings. Fuel is pumped onto the aircraft through flow-meters, which measure the fuel flow in gallons, and the aircraft system of fuel tanks have indicators which converts the volume of fuel contained within each tank into a quantity indicated in pounds. Fuel weight will fluctuate depending on temperature and can range in weight from 6.46 to 6.99 pounds per gallon. In this example 5,800 gallons of fuel are contained within the fuel tanks, at a conversion factor of 6.8 lb/gal, totaling 39,440 lb. (shown in this Column B, Row 4).
Column C representing the weight associated with the food, beverages and other catering items planned for consumption during the flight. Airlines often use catering carts, which are pre-loaded with food, beverages and ice, prior to being loaded onto the aircraft. There are several types of catering carts; either a lighter cart filled with trays of food, or a heavier cart filled with bottled water, canned beverages and ice. Each respective cart has a standard weight assigned to it based on the size and capacity of the cart. In this example, three of the heavier 128 lb. beverage carts are loaded onto the aircraft, totaling 384 lb. (shown in this Column C, Row 4).
Column D representing the weight of the flight crew. The airline flight crew weights are divided into two categories: pilot-crew and cabin-crew. FAA regulations regarding assumed/assigned/designated weight values used in the LBUM are contained within FAA Advisory Circular-AC120-27F. 27F designates the weight for each pilot at 240 lb. The pilot is assumed to be carrying personal baggage and additional flight charts and aircraft manuals onto the aircraft. FAA regulations require 2 pilots for this FAA Part 25 category of aircraft. FAA Regulations require 1 cabin attendant for each block of 50 passengers, for which the aircraft is certified to carry. AC120-27F designates the weight for each cabin attendants at 210 lb., which includes personal baggage. This example of the Boeing 737-800 aircraft is certified to carry a maximum of 174 passengers, thus the weight of 4 cabin attendants for this size of aircraft is applied. Combined pilot and cabin attendant weights total 1,320 lb. (shown in this Column D, Row 4).
Column E representing the “measured weight” of the cargo loaded. Each of the 6 respective cargo items for this example flight is pre-weighed on scales prior to being loaded onto the aircraft. The cargo weight for this example flight totals 750 lb. (shown in this Column E, Row 4).
Column F representing the weight of the checked bags (those bags which are loaded into the baggage compartments located below the aircraft cabin floor). AC120-27E designates average weight values for checked bags, depending on the assumed size of each bag. Average bag weights are assigned at 28.9 lb. each. For this flight there are 128 bags totaling 3,699 lb. (shown in this Column F, Row 4).
Column G representing the non-measured weight of 174 passengers for this flight. The FAA's published Advisory Circular AC120-27E designates weight values for average passenger weights at 190 lb. for summer weights and 195 lb. for winter weights, but these weight values are assumed weight averages, and are not a measured value for each flight. It is further assumed that during colder months, passengers will include more clothing as they board the aircraft. The summer average passenger weight of 190 lb. is used between May 1^{st}-October 31^{st} and winter weight of 195 lb. is used between: November 1^{st}-April 30^{th}. With this example, the higher 195 lb. winter weight assumption is being used. The passenger weight assumptions include carry-on items. Such carry-on items include bags, purses, small luggage, backpacks, etc. With all ticketed passenger boarding the aircraft, the assumed weight of 174 passengers totals 33,930 lb. (shown in this Column G, Row 4).
Column H representing the computed total weight of the aircraft. Summing the totals along Row 4, at the bottom of Columns A-H, equals 170,631 lb. for an aircraft total weight (shown in this Column H, Row 4). The 170,631 lb. accumulation is the calculated aircraft weight, as determined by the LBUM.
   The process shown above illustrates the compilation of known and assumed/designated weights values, to determine the aircraft total weight; and commonly referred to as the Load Build-UP Method.

Referring now to FIG. 5, there is shown an alternate chart, similar to the LBUM shown in FIG. 4; but within this FIG. 5 chart columns are rearranged to begin with the “measured” weight of the fully loaded aircraft; then subtracting each of the various measured, designated and known weight values of the LBUM; to determine the total passenger weight amount, further divided by the number of passengers listed on the load manifest, to identify the average weight of a typical passenger, for this respective flight.

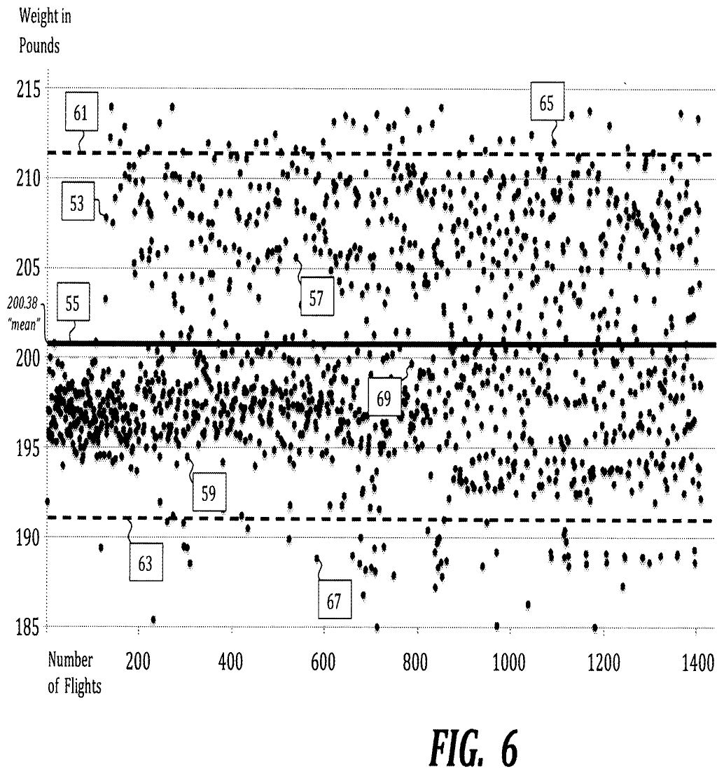

We begin this 2^{nd} example with:
Column A having a measured weight a fully loaded aircraft, now at 171,454 lb. (shown in Column A, Row 7).
Column B Row 4 shows the un-changed OEW of 91,108 lb. being subtracted from the 171,454 lb. measured weight of the fully loaded aircraft (shown in Column A, Row 7); resulting with a reduction in weight to 80,346 lb. (shown in Column B, Row 7).
Column C Row 3 shows 5,800 gallons of fuel, converting at 6.8 lb. per gallon to 39,440 lb. of fuel load for this flight (shown in Column C, Row 4). The fuel weight is subtracted from the prior reduced weight of 80,346 lb. (shown in Column B, Row 7); resulting with a further reduction in weight to 40,906 lb. (shown in Column C, Row 7).
Column D Row 3 shows three galley carts each weighing 128 lb., totaling 384 lb. of in-service catering for this flight (shown in Column D, Row 4). The catering weight is subtracted from the prior reduced weight of 40,906 lb. (shown in Column C, Row 7); resulting with a further reduction in weight to 40,522 lb. (shown in Column D, Row 7).
Column E Row 3 shows two pilots each weighing a designated 240 lb., and four cabin crew members designated at 210 lb. each; totaling 1,320 lb. for the entire flight crew for this flight (shown in Column E, Row 4). The crew weight is subtracted from the prior reduced weight of 40,522 lb. (shown in Column D, Row 7); resulting with a further reduction in weight to 39,202 lb. (shown in Column E, Row 7).
Column F Row 3 shows “cargo items 1-6” with various pre-measured weights, totaling 750 lb. as the cargo items for this flight (shown in Column F, Row 4). The cargo weight is subtracted from the prior reduced weight of 39,202 lb. (shown in Column E, Row 7); resulting with a further reduction in weight to 38,452 lb. (shown in Column F, Row 7).
   Note: the airline's load manifest data for each respective flight, including the total passenger-count and total checked baggage-count; is automatically sent wirelessly 23, from the airline's Network Operations Center computer 31, to the Centralized Data Service Center computer 27, just minutes prior to the aircraft's total weight being measured (shown in FIG. 1).
Column G Row 3 shows 128 bags, each assigned an FAA 120-27E designated weight of 28.9 lb.; totaling 3,699 lb. as the checked baggage for this flight (shown in Column G, Row 4). The checked baggage weight is subtracted from the prior reduced weight of 38,452 lb. (shown in Column F, Row 7); resulting with a further reduction in weight to 34,753 lb. (shown in Column G, Row 7).
   The methods of this invention are to identify the typical average passenger and average checked bag weights. Since both are the objective of this exercise, the model must initially use one of the AC120-27E designated average weight values in the model, to allow the model to continue to it findings of the opposing average weight. In this example, the 28.9 lb. represents the FAA designated average weight of a checked bag and is used, to allow Column H to complete the findings for the average passenger weight. With use of thousands of daily departures resulting in thousands of average passenger weight findings, these numerous average passenger weight findings are further averaged to determine a more precise average passenger weight. Once the more precise average passenger weight is identify; that refined passenger weight assumption is used in subsequent models allow for the determination and identification of a more precise average checked baggage weight, which shall be described in more detail in FIG. 6.
Column H Row 3 shows 174 passengers, which account for the 34,753 lb. of remaining weight for this flight (shown in Column H Row 4). Dividing 34,753 lb. by the 174 passenger-count, which is received from the load manifest, results in a determined average passenger weight of 199.73 lb. (shown in Column H, Row 7).
   The exercise described above is repeated many times, with the results further averaged to refine the typical average passenger weight to a more accurate and precise representation of the flying public.

Referring now to FIG. 6 there is shown a chart illustrating 1,400 audited airline flights, identifying variations of the average passenger weight associated with each flight. The 1,400 flights represent only ⅓ of the 4,200 daily departures from that respective airline, which operates the Boeing 737-800 aircraft.

The scatter of 1,400 data points are filtered to remove outliers, being those data points from the outer bands of higher and lower weight ranges; to determine a mean of the average passenger weights from the total flights surveyed. The column of vertical numbers shown on the left side of the chart, represent the range of average weights audited, and represents the total passenger population, and associated average passenger weight, from each respective flight. The average passenger weight range begins at the bottom of the chart with the lower weight range of 185 lb., and increases to the higher weight range of 215 lb.

The row of horizontal numbers shown along the bottom of the chart, represent each of the respective flights surveyed. The flights begin with the initial flight shown at the far left side of the chart, and conclude with the 1,400^{th} flight shown on the far right side of the chart.
Below is a summary of the chart's numeric indicators:
53 data point representing a single airline flight used to survey and determine the average weight of a passenger;
55 horizontal solid-line representing the mean of total surveyed flights, to determine average passenger weight across the 1,400 flights;
57 data point identified as a flight with the average passenger weight, greater than the mean;
59 data point identified as a flight with the average passenger weight, lesser than the mean;
61 horizontal dash-line representing the filtering threshold for identification of surveyed average passenger weight “high outlier”;
63 horizontal dash-line representing the filtering threshold for identification of surveyed average passenger weight “low outlier”;
65 data point identified as a flight with average passenger weight greater than the “high outlier” filter;
67 data point identified as a flight with average passenger weight lesser than the “low outlier” filter;
69 the specific data point representing the flight used as the Example in FIG. 5; determining the average passenger weight of 199.73

Horizontal solid-line 55 represents a mean weight of 200.38 lb., resulting from the 1,400 surveyed flights shown in this Example, with all 1,400 flights flown on the same colder day in January, to identify the average passenger weight for this series of flights. Flights flown on subsequent days, with temperatures 15°-20° warmer; might identify a lower average passenger weight, as the passengers on warmer days typically bring fewer heavy coats onboard the aircraft.

The flight associated with average passenger weight indicated by data point 53, and shown being above the surveyed average passenger weight shown by mean line 55, originated from the airline's hub in Chicago, Ill.; in a colder region of the air carrier's route structure.

The flight associated with average passenger weight indicated by data point 59, and shown being below the surveyed average passenger weight shown by mean line 55; originated from the airline's hub in Miami, Fla.; in a warmer region of the air carrier's route structure.

The FAA's designated 195 lb. “winter weight” assumption is to be used from November 1^{st} until April 30^{th}; which is a long period of time; and also assumes the weather patterns will be identical for that entire population pool, over the 181-day period.

The 1,400 surveyed flights indicate an average passenger weight of 200.38 pounds, which is 5.38 lb. heavier than the FAA's established “winter weight” of 195 lb. There are no specific explanations for this higher average passenger weight.

One possibility for the heavier weight is that the temperature that day might have been colder, and the flights operating in the northern geographic regions had passengers wearing more clothing. Another possibility is that the FAA designated weight assumes a passenger population mix of exactly 50% males and 50% females; with the male average weight including carry-on at 205 lb. as the winter weight; and the female average weight including carry-on at 184 lb. as the winter weight. There is the possibility that the passenger population had a greater percentage of males, than females; but this assumption cannot be made for every flight, each day.

This new system offers the potential for thousands of respective flights, operating in various geographic regions and operations at various times of the day; to generate large volumes of “specific” average passenger weights and offer significant improvements to the “typical” average weight assumptions used today.

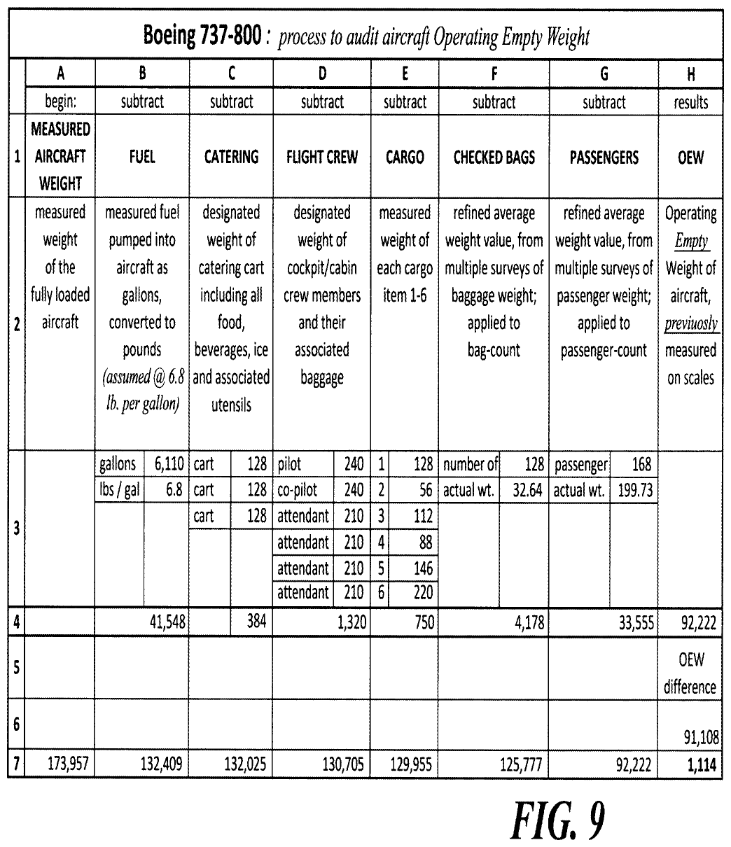

Still another possibility is that the airline's “fleet average empty weight” of the aircraft has become heavier as the aircraft age. Repairs made to cracks within the fuselage add weight to the aircraft, and placement of additional marketing/literature items within the seat backs can also be a source of this added phantom weight. An additional tool to validate and confirm the aircraft's empty weight is shown in FIG. 9.

The FAA recommends each airline choosing not to use the standard passenger weights, to survey their flying population on a minimum of 3-year interval. Additionally recommend 3-year intervals for re-measuring the operating empty weight of the aircraft; which together can allow the average weight assumptions of each of these categories to become stale over time. With the present invention, daily auditing to determine changes in the average passenger weight trends, compiles an expanding data-base, available for use by airlines to avoid these average passenger weight and empty aircraft weight assumptions to become outdated.

Combining these weight verification tools for confirming aircraft empty weight and accuracy of onboard fuel weight indicators (shown in FIGS. 9 and 10) support an ever-growing confidence of accuracy within the stockpile of various data-base information, used by airlines to refine and update their existing load planning assumptions, ie: LBUM (shown in FIG. 4).

As well as an OnBoard Weight and Balance System might “measure” the weight of the aircraft; it does not have the ability to anticipate or “plan” the loading of the aircraft; thus the need for airline load planners to have more accurate information, as they plan the loads of subsequent airline flights.

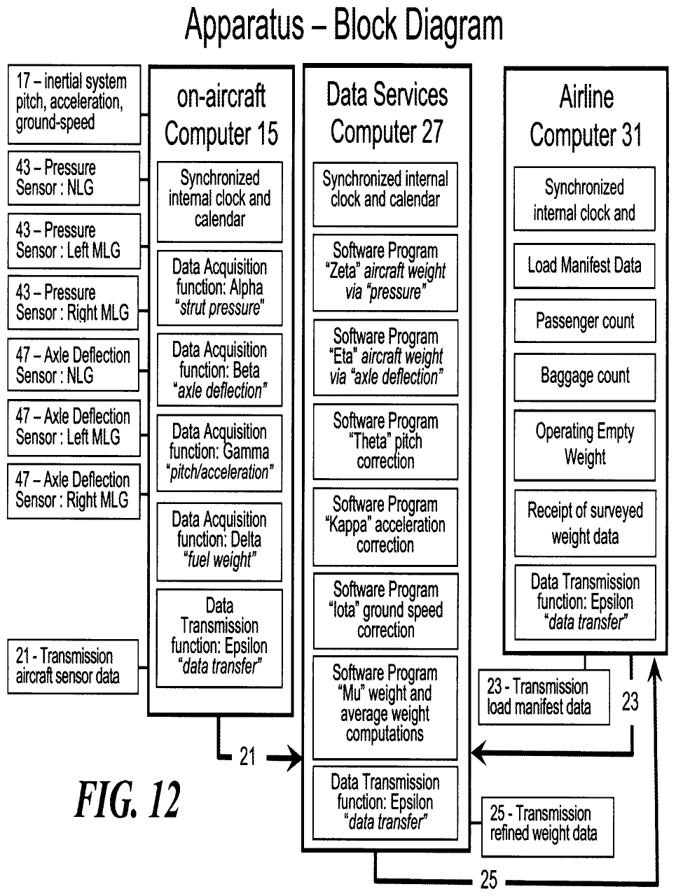

As additional aircraft are equipped with this system's hardware and software tools, they become additional sources for data-point inputs (see FIG. 11) to the growing discovery and revelations that average passenger weight trends, which are recorded, stored and analyzed within the data-base, indicate subtle changes to what have been historically referred to as the “typical” average passenger weight; to now become more refined values, into “specific” average passenger weights; associated with different geographic regions, the time of day for which the travel commences, and even the relationship to the type and size of aircraft being flown.

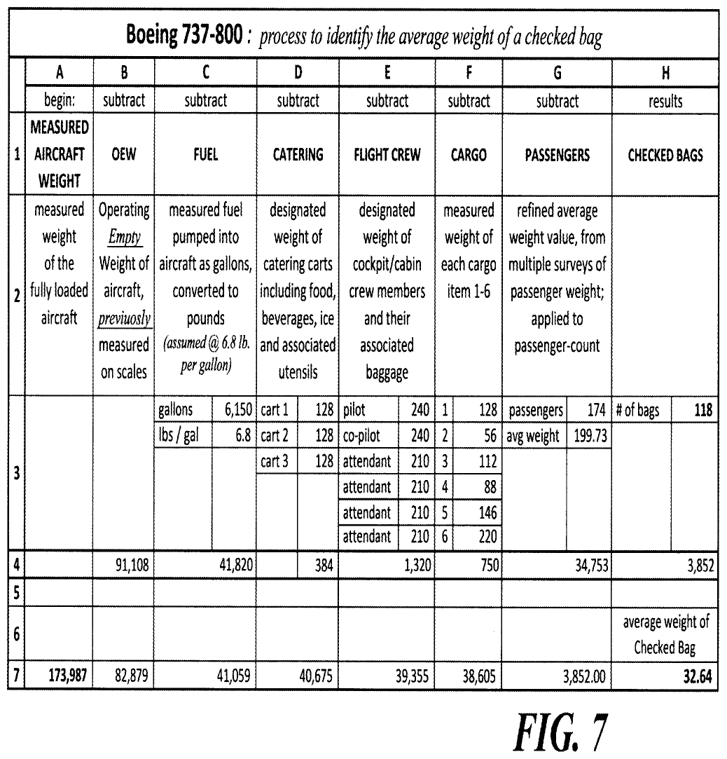

Referring now to FIG. 7, there is again shown a chart similar to that of FIG. 5, but in this 3^{rd} example of FIG. 7, Column G and Column H are reversed to identify the average weight of a checked bag. Checked bag weights are not measured prior to each flight, but instead are allocated with an FAA prescribed weight. Column G is now Passengers and Column H is Checked Bags. The measured total aircraft weight of this different flight is 173,987 lb (shown in Column A, Row 7).

Exchanging positions of Columns G and H allow the refined average passenger weight of 199.73 lb. (previously identified in FIG. 5) to be multiplied by the 174 passenger-count (shown in Column G, Row 3); resulting in a total passenger weight of 34,753 lb. (shown Column G, Row 4). The total passenger weight is subtracted from the reduced weight of 38,605 lb. (shown in Column F, Row 7), resulting with a further reduction in weight to 3,852 lb. (shown in Column G, Row 7). Dividing 3,852 lb. by the 118 checked baggage-count (shown in Column H, Row 3), recorded for this flight as listed on the load manifest, results in a determined average check baggage weight of 32.64 lb. (shown in Column H, Row 7).

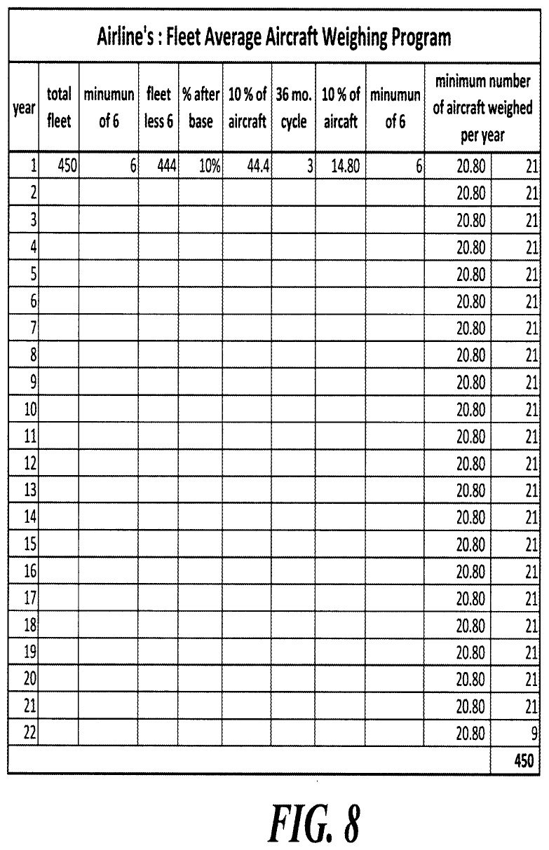

Referring now to FIG. 8 there is shown a different chart illustrating how aircraft operated by an airline with a large and common aircraft fleet-type, are selected for re-weighing to measure the aircraft's OEW; and shown in this chart the potential number of years for which a specific aircraft within the large fleet-type, may be allowed to operate, without having to be re-weighed. Regulatory Authorities allow airlines with large fleets of common aircraft types to avoid having to re-weigh every aircraft within their fleet, on the required 3-year intervals. The example shown in this FIG. 8 is for a domestic air carrier, operating a single airframe type of the Boeing 737-800, with the airline's total fleet size of 450 aircraft. Below are excepts from the FAA regulations related to the weighing of aircraft:

In particular, Advisory Circular AC120-27F:
Title 14—Code of Federal Regulations:
Part 91 subpart K and parts 121, 125 and 135

2.1.1 How Often are Aircraft Weighed?
2.1.1.1 Individual Aircraft Weighing Program. Aircraft are normally weighed at intervals of 36 calendar-months. An operator may extend this weighing period for a particular model aircraft when pertinent records of actual routine weighing during the preceding period of operation show that W&B records accurately reflect aircraft weights and CG positions are within the cumulative limits specified for establishment of BEW (see paragraph 2.1.3.1). Under an individual aircraft weighing program, an increase should not be granted that would permit any aircraft to exceed 48 calendar-months since its last weighing, including when an aircraft is transferred from one operator to another. In the case of helicopters, increases should not exceed the time that is equivalent to the aircraft overhaul period.
2.1.1.2 Fleet Weighing. An operator may choose to weigh only a portion of the fleet every 36 months and apply the weight and moment change determined by these sample weighings to the remainder of the fleet. For each aircraft weighed, the new aircraft empty weight and moment is determined by the weighing and entered in the aircraft weight log. The difference between this new aircraft weight and moment and the previous aircraft weight and moment shown in the log is the weight and moment change. The average of the weight and moment changes for the aircraft weighed as part of this fleet weighing is then entered as an adjustment to the aircraft weight logs for each of the aircraft in the fleet that were not weighed.

TABLE 2-2
Number of Aircraft to Weigh in a Fleet

| For fleets of- | An operator must weigh (at minimum)- |
|---|---|
| 1 to 3 aircraft | All aircraft |
| 4 to 9 aircraft | 3 aircraft, plus at least 50 percent of the |
| | number of aircraft greater than 3 |
| More than 9 aircraft | 6 aircraft, plus at least 10 percent of the |
| | number of aircraft greater than 9 |

In Summary: FAA/AC102-27F cites the minimum number of fleet aircraft for which the weight shall be re-measured in determining the “fleet average weight” is defined with a minimum of 6 aircraft, plus 10% of the remaining fleet size. The computations for this program is: 6+[(450−6)×10%]=44.4 aircraft. With rotation of 45 (44.4 rounded-up) individual aircraft within the common fleet type, must be re-weighed within 3-year intervals; equating to 15 aircraft per year. Adding the 6 aircraft minimum requirement, plus the 15 aircraft, equates to 21 aircraft to be re-weighed each year. Re-weighing only 21 aircraft per year, will take 211/2 years to re-weigh every aircraft within the 450 aircraft fleet.

Referring now to FIG. 9 there is shown a similar chart, as shown in FIG. 7; again with similar stepped weight reductions from the “measured weight” of 173,957 lb. (shown in Column A, Row 7) for the fully loaded aircraft, and again subtracting the designated and known weights of: fuel, catering, flight crew, cargo; and refined with more precise checked baggage and passenger weights (shown in FIG. 5 and FIG. 7).

In this 4^{th} example: the number of checked bags and associated checked baggage weight remained constant, but the passenger-count changed to 168 (shown in Column G, Row 3); resulting in the total passenger weight being 33,555 lb. (shown in Column G, Row 4). The total passenger weight is subtracted; resulting in a reduced weight of 92,222 lb. associated with the aircraft OEW (shown in Column G, Row 7). Computations to identify any potential change in the Operating Empty Weight of the aircraft resolved to an increase of 1,114 lb. (shown in Column H, Row 7); since the most recent OEW re-weigh for this aircraft.

Over time, with as many as 8 flights each day for that individual aircraft, numerous OEW validations and/or “weight revisions” to modify the OEW for that respective aircraft can be recorded, stored and used to update the airline's load planning programs, to increase overall accuracy in subsequent planned loads for that aircraft.

Referring now to FIG. 10 there is shown a similar chart, as shown in FIG. 8, with the stepped reductions from the “measured weight” of 174,132 lb. (shown in Column A, Row 7) for the fully loaded aircraft, and again subtracting the designated and known weights of: the updated OEW, catering, flight crew, cargo, refined total checked baggage weight, and refined total passenger weight; to identify 42,837 lb. of fuel load for the aircraft (shown in Column G, Row 7). In this 5^{th} example: subtracting the “conversion fuel weight” indicated as weight derived from the 6,100 gallons of fuel added, at the conversion rate of 6.8 lb/gal., resulting in a fuel load indication of 41,480 lb. (shown in Column H, Row 4), and subtracting the indicated fuel weight of 41,480 lb. from the “audited fuel weight” of 42,837 lb. (shown in Column G, Row 7) identifies a weight difference of 1,357 lb. (shown in Column H, Row 7). Continued monitoring to identify trends of discovered fuel load differences, and recognition of any consistently in a “same direction bias” offers aircraft maintenance technicians a new tool to better calibrate the fuel density compensators, used on today's aircraft fuel indictor systems.

Referring now to FIG. 11 there are shown multiple aircraft 1, 1a, 1b, 1c; loaded, and being pushed from the airport gates, for departures from various airports across the country, while wirelessly transmitting 21, 21a, 21b, 21c; load sensor data associated with a measured aircraft weight, to the Centralized Data Service Center first off-aircraft computer 27, which uses the ever increasing flow of weight data to compile an increasingly larger library and data-base of average passenger weights and average baggage weights, categorized by numerous and various dates, time of day, and geographic regions.

Referring now to FIG. 12 there is shown a block diagram illustrating the functions of on-aircraft computer 15, with various sensor inputs; first off-aircraft Centralized Data Services computer 27 with various data inputs and Software Programs; and Airline second off-aircraft computer 31. Also shown are wireless-transmission 21 providing sensor data form the aircraft, and wireless-transmission 23 providing load manifest and OEW data, both transmitted to Central Data Services computer 27. Wireless-transmission 25 to the Airline's second off-aircraft computer 31, delivers the compiled and automated survey results for refined average passenger and average baggage weights, all being part of the apparatus of the invention. Sensor inputs to on-aircraft computer 15 include multiple inputs from (respective nose 3, left-main 5 and right-main 7 landing gear) strut pressure sensors 43. Sensor inputs to on-aircraft computer 15 also include multiple inputs from (respective nose 3, left-main 5 and right-main 7 landing gear) landing gear axle deflection measuring sensors 47. An onboard inertial system 17, which measures aircraft pitch, 3-axis acceleration and ground speed, is a standard component on aircraft 1. On-aircraft computer 15 has an optional cockpit display and keypad 19 (not shown), which allows pilots to discern information from and input data to on-aircraft computer 15. The on-aircraft computer 15 outputs of data and information are transmitted via a wireless transmission 21, to a wireless receiver attached to the Centralized Data Services first off-aircraft computer 27.

On-aircraft computer 15, Data Services first off-aircraft computer 27 and Airline second off-aircraft computer 31 are equipped with internal synchronized clocks and calendars, to document the time and date of recorded and received sensor and data transmissions.

On-aircraft computer 15 has multiple data acquisition/transmission functions, which include:
Data Acquisition function “Alpha” which monitors nose and main landing gear internal strut pressure and stores the recorded data with time and date references to respective strut pressure measurements to such time as the data is transmitted to Centralized Data Services computer 27.
Data Acquisition function “Beta” which monitors nose and main landing gear axle deflections; and stores the recorded data with time and date references to respective axle deflection measurements to such time as the data is transmitted to Centralized Data Services computer 27.
Data Acquisition function “Gamma” which monitors changes in aircraft pitch, acceleration and ground-speed; stores the recorded data with time and date references, to such time as the data is transmitted to Centralized Data Services computer 27.
Data Acquisition function “Delta” which receives fuel weight data from onboard fuel indictors; stores the recorded data with time and date references, to such time as the data is transmitted to Centralized Data Services computer 27.
Data Transmission function “Epsilon” which wirelessly transmits 21 the time and date referenced landing gear sensor data, aircraft movement data and fuel weight data to Centralized Data Services computer 27.

Centralized Data Services first off-aircraft computer 27 has capabilities for wireless reception 21 of multiple landing gear sensors, aircraft movement, and fuel weight data; and wireless reception 23 of the load manifest data and aircraft OEW. Additionally provides wireless-transmission 25 of surveyed weight data back to the Airline's computer 31. Data Services computer 27 has software programs and data acquisition/transmission functions which include:
Software Program “Zeta” which processes received pressure sensor data from the respective nose and main landing gear to resolve into values equivalent to the weight supported at each respective landing gear and total aircraft weight,
Software Program “Eta” which processes received axle deflection sensor data from the respective nose and main landing gear to resolve into values equivalent to the weight supported at each respective landing gear and total aircraft weight,
Software Program “Theta” which processes received aircraft pitch data from the on-aircraft component to resolve into a value of off-set equivalent to the aircraft being horizontal,
Software Program “Iota” which processes received aircraft ground speed data from the on-aircraft component to resolve into a value of off-set equivalent to the aircraft being stationary.
Software Program “Kappa” which processes received aircraft 3-axis acceleration data from the on-aircraft component to additionally resolve into a value of off-set equivalent to the aircraft being stationary.
Software Program “Mu” which processes the weight data from Programs Zeta and Eta to measure the fully loaded weight of the aircraft and further identify the average passenger weight (shown in FIG. 5), average baggage weight (shown in FIG. 7), changes to the OEW (shown in FIG. 9) and monitoring aircraft fuel indicator accuracy (shown in FIG. 10). Airline's off-aircraft computer 31 (shown in FIG. 1) provides and transmits the respective flight's Load Manifest information, including the passenger count and checked baggage count, assigned to the current date and flight number, to Software program “Mu”; to complete the respective average weight determinations. As average passenger and checked baggage weight values are determined, recorded and stored within the data-base; they are assigned and cross-referenced into categories of: date, time, aircraft size, and geographic region; allowing Software Program “Mu” to process the current data capture, and use it as reference points in the comparison of, and changing trends in, average weight patterns. The changing trends and patterns of average passenger and checked baggage weights are monitored and used as a base-line benchmark, in subsequent average weight computations, to increase the confidence level when determining a value for average passenger and checked baggage weight values. This allows the logic within the software program “Mu” to identify and learn as time progresses, with the additions of the ever-expanding individual data-points complied within the data-base. Airline load planning programs within airline's second off-aircraft computer 31 (shown below and in FIG. 1) used the current day's updated average weight values, for load planning purposes for next day's flights.
Data Transmission function “Epsilon” which wirelessly transmits 25 refined average weight data to Airline computer 31.

Airline's second off-aircraft computer 31 has capabilities for wireless transmission 23 for aircraft specific Load Manifest data and Operating Empty Weight; and also wireless reception 25 of surveyed weight data, which includes:
Average passenger weight, associated with the time and date, allowing the airline to categorized the average passenger weight, including changes of passenger and baggage weight trends corresponding to calendar dates, replacing current assumptions which have the world's population gaining 5 pounds during the 24 hour period from October 31^{st} to November 1^{st}, as the airline industry coverts from assumed Summer weights to assumed Winter weights. Additionally, as the world's population looses 5 pounds during the 24 hour period from April 30^{th} to May 1^{st}, as the industry coverts from assumed Winter weights, back to assumed Summer weights.
Average passenger weight, associated with the time and date, allowing the airline to categorized the average passenger weight, including weight trends corresponding to the time of day, allowing airlines to utilize identified patterns in passenger travel which finds weight differences associated with the departure time of travel.
Average passenger weight, associated with the departure city and arrival city, allowing the airline to categorized the average passenger weight, including weight trends corresponding with travel to and from specific destination cities, allowing airlines to utilize identified patterns in passenger travel that finds weight differences associated with the cities offering vacation destinations, to those primarily supporting business activities. Allowing airlines to monitor trends of passengers returning from vacation destinations, bringing more carry-on items into the aircraft cabin. Allowing airlines to monitor trends of passengers departing to and arriving from geographic regions, with typically lesser-weight populations, compared to regions with heavier-weight populations.
Average baggage weight, associated with the time and date, allowing the airline to categorized the average bag weight, including weight trends corresponding to the dates of the calendar.
Average baggage weight, associated with the departure and destination cities, allowing the airline to categorized the average bag weight, including weight trends corresponding to geographic regions.
Monitoring of Operating Empty Weight of the aircraft, and associated increases in the weights of empty aircraft over time. Aircraft typically never get lighter, but often get heavier as soiled carpets and seats provide additional weight to the aircraft, along with leaked and trapped fluids within the aircraft, and associated collection of dirt by those fluids. The non-reported additions of in-flight magazines and literature, placed within the 100s of seat-backs on the aircraft can generate non-recognized weight increases.
Accuracy validation of aircraft fuel weight indicators.
Data Transmission function “Epsilon” which wirelessly transmits 23 the specific flight's load manifest data to Centralized Data Services computer 27.

The onboard aircraft weight measuring system depicted herein is one means, but not the only means to measure the weight of a fully loaded aircraft. Other means of measuring the aircraft weight may be used, without diverging from the spirit of the invention herein described.

Having a measured aircraft weight, pilots are assured that a significant weight error will not go un-noticed, which might create a safety hazard for a particular flight. Improved operational safety of the aircraft can be established with the implementation and usage of landing gear sensor data to measure aircraft weight and CG, rather than current weight assumptions provided in the Regulatory guidance offered within AC120-27F.

Described within this invention are methods and strategies developed; in which the whole is now greater than the sum of its parts. Each of the sub-practices of this invention are elements which build upon each other, and strengthen the foundation of justification for the realization that the aircraft operational criteria and Regulations dating back 30 years, have worked well for decades; but the development of new technologies, procedures and the careful implementation and monitoring of such practices offer justification through a finding of an Equivalent Level of Safety, for aviation Regulatory Authorities to allow for an automation in the survey processes to develop more precise average weight assumptions, used in aircraft load planning programs.

Where previous systems using assumed weight values have been used as a tool to aide pilots with load planning procedures, to help avoid aircraft departures beyond the aircraft safe operational limits, this new invention uses the apparatus and methods to increase the safety of the aircraft, by bringing to better light that current weight assumptions fall short in the accurate determination of aircraft weight and corresponding aircraft CG.

Although an exemplary embodiment of the invention had been disclosed, it will be understood that other applications of the invention are possible and that the embodiment disclosed may be subject to various changes, modifications, and substitutions without necessarily departing from the spirit and scope of the invention. Therefore, it is intended that this invention not be limited to the particular embodiment disclosed as the best mode contemplated for carrying out the invention, but that the invention will include all embodiments falling within the scope of this disclosure.

1. A method of weight survey automation, to establish an average weight of airline passengers, comprising the steps of:
a) providing an aircraft, the aircraft comprising a fully loaded weight, the fully loaded weight comprising a non-measured total passenger weight and a known total non-passenger weight, the non-measured total passenger weight comprising a total weight of the airline passengers, the airline passengers being within the aircraft;
b) measuring the fully loaded weight of the aircraft to determine a measured aircraft weight;
c) reducing from the measured aircraft weight, the total non-passenger weight;
d) determining a calculated remaining weight, corresponding to the total passenger weight, within the aircraft;
e) providing a total number of the passengers from a load manifest;
f) using the total number of the passengers and the calculated remaining weight, determining a calculated average weight of the passengers within the aircraft.

2. The method of claim 1 wherein the total non-passenger weight comprises an operating empty weight of the aircraft.

3. The method of claim 1 wherein the total non-passenger weight comprises fuel within fuel tanks of the aircraft.

4. The method of claim 1 wherein the total non-passenger weight comprises a measured weight of catering loaded onto the aircraft.

5. The method of claim 1 wherein the total non-passenger weight comprises a designated weight of a flight crew of the aircraft.

6. The method of claim 1 where the total non-passenger associated weight comprises a measured weight of cargo loaded onto the aircraft.

7. The method of claim 1 where the total non-passenger associated weight comprises a designated weight for a total number of checked bags loaded onto the aircraft.

8. A method of weight survey automation, to establish an average weight of checked bags loaded onto an aircraft, comprising the steps of:
a) providing the aircraft, the aircraft being fully loaded and comprising a non-measured total checked bag weight and a total non-checked baggage weight, the total non-checked baggage weight being weight other than the total checked bag weight;
b) measuring a weight of the fully loaded aircraft to determine a measured aircraft weight;
c) reducing from the measured aircraft weight, the total non-checked-baggage weight;
d) determining a calculated remaining weight, corresponding to the total checked-bag weight;
e) providing a number of checked-bags from a load manifest; and
f) using the number of checked bags and the calculated remaining weight, determining a calculated average weight of the checked-bags within the aircraft.

9. A method of weight survey automation, to validate an operating empty weight of an aircraft, comprising the steps of:
a) providing a previously measured operating empty weight of an aircraft, being a first operating empty weight;
b) measuring a fully loaded weight of an aircraft to determine a measured aircraft weight;
c) reducing from the measured aircraft weight, all non-empty operating weight associated weights, within the aircraft, being a second operating empty weight; and
d) determining a difference between the first operating empty weight to that of the second operating empty weight.

10. A method of weight survey automation, to validate the accuracy of fuel weight indicators of an aircraft, comprising the steps of:
a) determining a first fuel weight, from onboard fuel indicators;
b) measuring a fully loaded weight of a respective aircraft to determine a measured aircraft weight;
c) reducing from the measured aircraft weight, all non-fuel associated weights, within the aircraft, being a second fuel weight; and
d) determining a difference between the first fuel weight to that of the second fuel weight.

11. A system for determining average passenger and baggage weights in aircrafts, the system comprising:
a. one or more aircraft, each of said aircraft comprising an on-aircraft computer communicatively linked to a plurality of sensor inputs, said on-aircraft computer being adapted to analyze sensor data associated with the plurality of sensor inputs;
b. first and second off-aircraft computers communicatively linked to the on-aircraft computer;
c. the first and second off-aircraft computers and the on-aircraft computer each being adapted to send and receive data transmissions and each being adapted to analyze such data transmissions;
d. wherein data transmissions communicated from the on-aircraft computer to the first off-aircraft computer comprise load manifest and operating empty weight data;
e. wherein data transmissions from the first off-aircraft computer to the second off-aircraft computer comprise compiled and automated survey results comprising calculated average passenger and checked bag weights; and
f. wherein said second off-aircraft computer is adapted to analyze such calculated average passenger and checked bag weights to create refined average passenger and checked bag weights.

12. The system of claim 11, the plurality of sensor inputs comprising strut pressure sensors, deflection sensors, and inertial system sensors.

13. The system of claim 12, wherein the on-aircraft computer comprises a cockpit display and keypad, the cockpit display being structured and arranged to display input data comprising sensor data.

14. The system of claim 11, wherein the on-aircraft and first and second off-aircraft computers comprise internal synchronized clocks and calendars adapted to document a time and date sensor data is generated.
